(19) United States
(12) Patent Application Publication
(10) Pub. No.: US 2003/0103261 A1
(43) Pub. Date: Jun. 5, 2003

(54) Techniques for reducing observed glare by using polarized optical transmission & reception devices

(76) Inventor: Ranald Hay, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 10/302,552

(22) Filed: Nov. 22, 2002

Related U.S. Application Data
(63) Continuation-in-part of application No. 09/756,898, filed on Jan. 9, 2001.

(51) Int. Cl. F21V 9/14; G02B 5/30; G02B 27/28

(52) U.S. Cl. 359/352; 359/493; 362/19

(57) ABSTRACT

A visibility-enhancing system includes an adjustment mechanism for adjusting the polarization of a light source relative to the polarization of a viewing filter, so as to provide adjustable control of visual contrast between interposing media and an object to be viewed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. An observer adjusts at least one of the source polarization angle determination mechanism and the filter polarization angle adjustment mechanism so as to improve the visibility of the object to be viewed in the presence of interposing media.

### RELATED APPLICATIONS

This is a Continuation In Part of patent application Ser. No. 09/756,898, filed on Jan. 9, 2001, entitled Fog Vision Device.

### FIELD OF THE INVENTION

The present invention relates generally to the field of optics, and, more specifically, to devices and techniques for controlling reflected glare.

### BACKGROUND ART

“Glare” may be conceptualized as a form of visual noise included within a scene containing visual information. This visual noise can adopt any of various forms, from the inconvenient to the dangerous. For example, when driving towards the sun, an icy road is transformed into a sea of fire. Such a situation may exist whenever the relative intensity of road surface reflections is greater than that of ambient light reflections returned by vehicles in the distance. At night, copious raindrops or snowflakes from a passing storm produce a blinding glare from the driver's own headlamps, obscuring lane markings, objects at the side of the road, and oncoming vehicles. In this case, reflections from each of a multitude of water droplets act as individual noise sources. When light reflections from these noise sources are aggregated, the amount of overall visual noise may obscure important visual information in the distance. Pursuant to another illustrative scenario, a thick fog rolls in across the valley, and headlights from oncoming vehicles generate an opaque wall of white iridescence. Here, the glare is gentle, but no less dangerous. These are all examples of uncontrolled light glare, which is quite abundant in nature.

In addition to driving, light glare is a problem in many other settings. Specular glare from reflective surfaces can impede the progress of jewelers working on intricate details. Specular glare also causes problems with certain types of surveillance equipment. Night vision devices typically use a source of infrared radiation to illuminate objects for viewing. This source may be required in cases where insufficient ambient optical energy exists, such as on starless nights, or in buildings without windows or electricity. A sensitive infrared light amplifier tube is designed to handle the relatively low levels of infrared and visible radiation that are reflected back to the night vision device. However, specular glare from reflective bright surfaces, such as glass, may overload the sensitive light amplifier tube, causing momentary “glare blindness” that lasts for as long as several seconds. Invisible infrared illuminators are often utilized in critical operational environments, such as law enforcement and national defense, where a blinding delay of a few seconds could have devastating and far-reaching consequences.

From an analytical standpoint, light may be conceptualized as a particle or as a wave. However, when studying the problem of glare, it is useful to consider the wavelike aspect of light. These waves are made up of electrical and magnetic fields, oscillating at right angles to each other and at right angles to the direction in which the light is traveling. Most light, irrespective of whether it is produced naturally or artificially, includes electric field components situated in virtually all directions perpendicular to the direction of propagation.

By way of example, if the sun is on the Western horizon, the light it sheds toward the East will have electric fields oscillating up and down, north and south, and every direction in between. Such light is termed “unpolarized” light. Next, suppose that the sun is somewhat above the Western horizon, with a smooth water surface at the ground. Some of the light will penetrate into the water, and some light will be reflected. But if one examines this situation in more detail, an interesting phenomenon is observed. The electric fields that are oscillating in a direction across the surface of the water (in the present example, in a north-south direction) have trouble penetrating the water and are mostly reflected. At the same time, electric fields that are at least partially perpendicular to the water penetrate easily and produce only a little reflection. As a result, both the reflected light, as well as the light entering the water, become “polarized”.

Polarization simply refers to the fact that the electric field component of the light lies substantially in one plane. In other words, the light is dominated by waves having the same direction of electric field oscillation. Most of the light reflected from a horizontal surface will have an electric field that lies in a horizontal plane. Accordingly, it is said that such light is horizontally polarized. Ice, glass, or any other smooth surface that does not conduct electricity (or that is a poor conductor) behaves in much the same way as the above-described horizontal surface, with one notable exception. These smooth surfaces are not necessarily oriented horizontally, and so the light that they reflect will be polarized, but not necessarily in a horizontal direction. Such smooth objects are said to provide specular reflections. Metals, which conduct electricity, do not polarize light on reflection.

The concept of polarization may be advantageously exploited to develop devices for passively reducing glare. As a matter of fact, many existing devices are based upon the foregoing observation that smooth surfaces will reflect certain polarizations of light much more efficiently than other polarizations. A polarized filter can be oriented so as to attenuate these polarized reflected components, while, at the same time, allowing other light to pass through. For instance, polarized sun glasses are used to reduce unwanted glare from roadways and from snow.

Other devices which polarize light in order to reduce glare are known. For instance, U.S. Pat. No. 3,876,285 issued to Schwarzmüller, describes a polarization device for a vehicle's headlamps to reduce “dazzle” in the eyes of oncoming traffic. This device and similar devices involve the transmission of polarized light at a fixed, non-adjustable polarization. Schwarzmuller is directed to solving an efficiency problem whereby, if a conventional polarizing screen is placed in front of a source of unpolarized light, the light intensity will be reduced by about one-half. Utilizing a principle known to those skilled in the art as “light recycling”, Schwarzmuller changes the polarization of the component that would normally be filtered out, so as to reorient this component, and then recombines it with the filtered light, so as to provide a light beam that is not substantially reduced in intensity over the original unfiltered beam. However, no mechanism is provided to readily adjust the direction of polarization of the transmitted light. In addition, no mechanism is provided to adjust the polarization of light to be filtered out at the observers's eyes. Finally, this system is limited in application to automotive headlamps and the like, and is not adaptable to solving a broader range of light glare problems.

Another prior art glare reduction scheme is disclosed in U.S. Pat. No. 5,276,539, issued to Humphrey. Humphrey is directed to operational environments where the relative intensities of certain elements in a scene, either reflected or directly illuminated, obscures other information. A strobed electro-optical filter is utilized to “clip” or limit the maximum brightness level of a scene such that no scene element will have a brightness greater than a predetermined threshold. In this manner, even the brightest scene element will not exceed a known level, thereby providing an enhanced measure of safety and predictability. Nevertheless, a major shortcoming of this approach is that it does not discriminate between desired visual information and noise. Desired information and noise are both subjected to the same clipping/limiting process.

Yet another prior art glare reduction system is disclosed in U.S. Pat. No. 6,145,984, issued to Farwig. Farwig utilizes a polarized lens system that selectively passes red, green, and blue light while, at the same time, substantially attenuating light at all other wavelengths (orange, yellow, and violet). This approach takes advantage of the fact that the three primary colors of light are red, green, and blue, a direct result of the human eye being equipped with three different types of cones that are responsive to, respectively, red, green, and blue wavelengths of light. Theoretically, the human eye should be able to “reconstruct” any color from various combinations of green, red, and blue light. Unfortunately, as in the case of the Humphrey patent, no mechanism is provided for distinguishing desired visual information from noise. Moreover, by its very nature, the Farwig technique is only applicable to visible light, and cannot be adapted to infrared wavelengths.

Another illustrative glare reduction technique is set forth in U.S. Pat. No. 6,088,541, issued to Meyer. Meyer describes a system for flash cameras which is intended to reduce glare caused by the flash in a manner so as to not disturb color balance.

Two stationary panchromatic reflective sheet polarizing filters are used. A first filter is incorporated within the flash unit to provide a polarized light source. A second filter, mounted over the camera lens, excludes light originating from the flash which has been specularly polarized by the photographic scene.

A major shortcoming of Meyer's approach is the lack of a glare adjustment mechanism. Meyer implicitly assumes that all glare is bad, and his techniques are predicated upon the notion that glare should always be reduced to the maximum extent practicable. Accordingly, Meyer fixes the first and second polarized filters in a mutually orthogonal configuration, or, alternatively, utilizes two circularly-polarized filters with the same sense of polarization. Although this geometry might maximize the reduction of visible glare, it does not represent the desired arrangement for many photographic or other types of scenes. Depending upon the orientation of the flash unit and the lens relative to a scene, as well as the orientation of reflective objects within the scene, the fixed positions of the first and second filters may not be optimally situated to achieve a desired amount of glare reduction. Moreover, this approach only considers transient glare that is generated by the flash unit, whereas a photographic scene may be continually illuminated by other glare-producing light sources.

The “maximum glare reduction” geometry described in the foregoing paragraph raises serious safety concerns. Assume that an individual is driving a car in foggy conditions. A few hundred feet ahead, a dark grey vehicle has slowed to a near stop. Using the approach outlined in Meyer, full or maximum elimination of any tell-tale reflections from this vehicle may well result in a collision, especially if the headlamps on the grey vehicle are not illuminated. In this scenario, the concept of noise versus information is critical. In some circumstances, glaring reflections will return useful data to a viewer's eyes. An adjustable system would permit some (undesirable) glare to be viewed, but it would also permit critical reflections from the grey vehicle to be seen at a distance. Unfortunately, Meyer's approach does not allow for this safety trade-off.

Refer to FIG. 1, which is a diagrammatic representation of an illustrative prior-art approach as outlined in the aforementioned Meyer patent. A flash camera 01 contains a vertically polarized flash filter 02 and a horizontally polarized lens filter 03. The camera is aimed at a glass bottle 04 with a cork stopper 05. A light ray 10 emitted during a flash will be polarized vertically, as indicated by vector arrows 11, and strike the bottle at location 12. The specular reflective property of bottle 04 returns a ray 13 to towards a camera lens and filter 03, maintaining vertical polarization indicated by vector arrows 14, where the fixed orthogonal relationship between polarization vectors results in nearly total absorption of ray 13. A ray 20, emitted from flash 02, is vertically polarized as indicated by vector arrows 25. Ray 20 reaches the cork stopper 05 at location 21, where the light is absorbed and re-emitted as a ray 22 headed towards the camera lens and filter 03. Re-emitted ray 22, however, is not uniformly polarized. The polarization of ray 22 is described by two approximately equal, orthogonal vectors, horizontal vector 23 and vertical vector 24. Upon interaction with horizontally polarized camera lens and filter 03, vertical polarization vector 24 will be almost totally absorbed, while horizontal polarization vector 23 will be almost totally permitted to pass.

Meyer's approach is commonly utilized in the field of photomicography. Pursuant to some state-of-the-art photomicrographic systems, a first polarizing lens is fixed at right angles with respect to a second polarizing lens, or the two lenses are both circularly-polarized and use a common circular axiality. These systems are similar to the teachings of Meyer in that the total elimination of specular reflections is considered to be a desired outcome. However, glare elimination is not the same thing as glare control. To achieve certain photographic effects, or to enhance the visibility of certain objects relative to other objects, a controlled amount of glare may be preferred to a total reduction of all glare.

A further illustrative prior art glare reduction technique is set forth in International Patent No. WO 84/01012, issued to Brooks. Referring now to FIG. 2, Brooks describes a lighting system for vehicles intended to reduce glare from headlights utilizing polarized light. A vehicle 201 is configured with a pair of headlights 202 and a windshield 203. Both headlights 202 and windshield 203 are polarized at the same angle, in this case at 315° (which could also be conceptualized as negative 45°), with vectors drawn illustratively from the lower right to upper left relative to the forward direction of travel. Similarly, vehicle 210 is equipped with headlights 213 and windshield 212, also polarized at 315° (i.e., negative 45°), with vectors drawn illustratively from the lower right to upper left relative to the forward direction of travel. Windshields 203, 212 will correspondingly absorb light with polarization vectors at an orthogonal angle, in this case positive 45°, to their forward direction of travel. It is important to note that the negative 45° angles of polarization become relatively orthogonal, at positive 45°, when the direction of vehicular traffic is reversed.

As vehicle 201 approaches an oncoming vehicle 210 in traffic, light from headlights 202 will reach vehicle 210 along a path 220 with polarization vector 221 at 45° relative to vehicle 203, or at positive 45° relative to vehicle 210. As vehicle 201 is approached by vehicle 210 in traffic, light from headlights 213 of vehicle 210 traveling along oncoming path 222 will have polarization vectors 223 at relative positive 45°, or at 45° relative to the direction of travel of oncoming vehicle 212. Windshield 212, fixedly positioned at a relative polarization absorption angle orthogonal to headlamp 202, will absorb most of the light following path 220. Similarly, windshield 203, fixed at a relative polarization absorption angle orthogonal to headlamp 213, will absorb most of the light following path 222. In this manner, each driver's vision is protected from intense point-source light emanating from the headlamps of oncoming vehicles.

Brooks' approach is similar to the techniques described by Land in U.S. Pat. No. 2,458,179. In both disclosures, the polarization angles of the headlights and windshields of any particular vehicle would be fixed at 45°. In order for glare reduction to occur, on-coming vehicles must be similarly equipped.

Neither the Brooks nor the Land patents disclose a mechanism for reducing glare from reflective atmospheric media or brilliant reflective objects in the distance. Neither patent discloses any adjustment mechanism, either manual or automatic, for adjusting the relative angle between the polarizations of the headlamps and the windshields.

### OBJECTS AND SUMMARY OF THE INVENTION

It is an object of the present invention to provide a glare controlling apparatus for adjusting the visible contrast of glare and re-emitted light from objects onto which light is shed. Another object of the present invention is to provide a glare controlling apparatus which selectively controls the glare from interposing media such as rain and fog, to enhance the visible contrast between (a) objects onto which light is being shed, such as a vehicle in the distance, and (b) rain, snow, and/or fog.

A further object of the present invention is to provide a glare adjustment mechanism for enhancing a photographed or viewed scene.

Another object of the present invention is to provide a glare adjustment mechanism for improving the visibility of a viewed or photographed scene.

The above and other objects of the invention are realized in the form of systems that include an adjustment mechanism for adjusting the polarization of a light source relative to the polarization of a viewing filter, so as to permit adjustment of visual contrast between interposing media and an object to be viewed and/or photographed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. At least one of the source polarization angle determination mechanism and the filter polarization angle adjustment mechanism are adjusted. The adjustment is implemented so as to provide at least one of: (a) enhancing the visibility of an object to be viewed in the presence of interposing media; (b) enhancing a photograph of an object, and (c) enhancing a viewed scene. Such enhancement may include improving the visibility of a target object within a scene, degrading the visibility of an object within a scene, providing a desired artistic or aesthetic visual effect, or the like.

A polarized light source, when made to shine through interposing media such as water droplets, will ordinarily refract and reflect from individual droplets in a specular manner, such that the reflected light will be polarized at a substantially constant angle. These water droplets may represent, for example, fog, snow, and/or rain. The reflections are specular, irrespective of whether the droplets are in liquid, vaporous, vaporous aerosol, crystallized, and/or frozen form. Vaporous aerosols may refer to fog, steam, sprays, mists, and the like. On the other hand, light returning from objects in the distance will comprise both polarized and randomly polarized components from refraction, such that the specular component of the reflected light is not of relatively high magnitude. Adjustment of the angle of polarization of the light source relative to the angle of absorption of the polarization filter permits none, some, or all of the polarized light to be absorbed, as desired, controlling the relative brightness of non-specular objects in the distance (i.e., cars, telephone poles, trees) relative to the brightness of the glare from specular objects such as rain, fog, and snow.

Pursuant to a further embodiment of the invention, the polarized light source, when made to shine against shiny reflective objects such as glass or chrome plated objects, will ordinarily reflect strongly from the surface, obscuring other objects of interest. Such strongly reflected light can cause temporary “glare blindness” in night vision infrared amplifier tubes, or cause distracting highlights for the jeweler. It is known that polarized light reflecting from bright reflective nonconductive surfaces will retain a constant angle of polarization. Adjustment of the angle of polarization of the light source relative to the angle of absorption of the polarization filter permits polarized highlights reflected by shiny objects to be absorbed by the filter, thus greatly enhancing visual clarity.

According to an alternate embodiment of the invention, the angle of polarization of a light source is adjusted relative to the angle of absorption of a given surface onto which the emitted light shines. This technique permits adjustment of the proportion of the emitted light to be absorbed into the surface, greatly controlling the proportion of light which the surface will reflect back to a viewer as glare. The present embodiment may or may not be utilized in conjunction with a polarization-adjustable viewing filter. Illustratively, such a system may be employed to reduce glare from street lamps and airport runway lamps, and also for controlling glare in photographic, cinematic and display applications.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The foregoing features of the present invention may be more fully understood from the following detailed description of specific illustrative embodiments thereof, presented hereinbelow in conjunction with the accompanying drawings, in which:

FIG. 1 is a diagrammatic representation of a first illustrative prior art glare reduction system.

FIG. 2 is a diagrammatic representation of a second illustrative prior art glare reduction system.

FIG. 3 is a diagrammatic representation of a glare reduction system constructed in accordance with a preferred embodiment of the invention.

FIGS. 4A and 4B are diagrammatic representations setting forth, respectively, a prior art illumination technique and an illumination technique constructed in accordance with a first alternate embodiment of the invention.

FIG. 5 is a diagrammatic representation of a second alternate embodiment of the invention for use in the context of night vision equipment and/or photography.

FIG. 6 is an illustrative photograph taken in accordance with prior art flash illumination techniques that do not employ polarization filters.

FIG. 7 is an illustrative photograph taken using a system similar to that of FIG. 5, wherein the polarization angle between an illumination source polarization filter and a light receiving polarization filter is adjusted to approach orthogonality.

FIG. 8 is an illustrative photograph taken using a system similar to that of FIG. 5, wherein the polarization angle between an illumination source polarization filter and a light receiving polarization filter is adjusted to an intermediate point between identical polarization and orthogonal polarization, so as to enhance a specific scene.

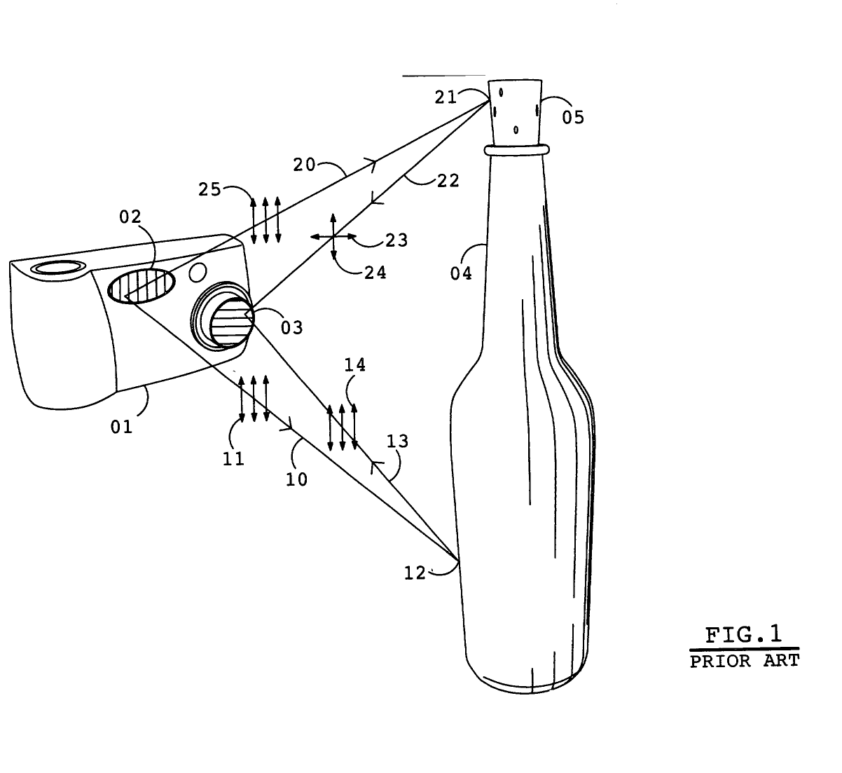

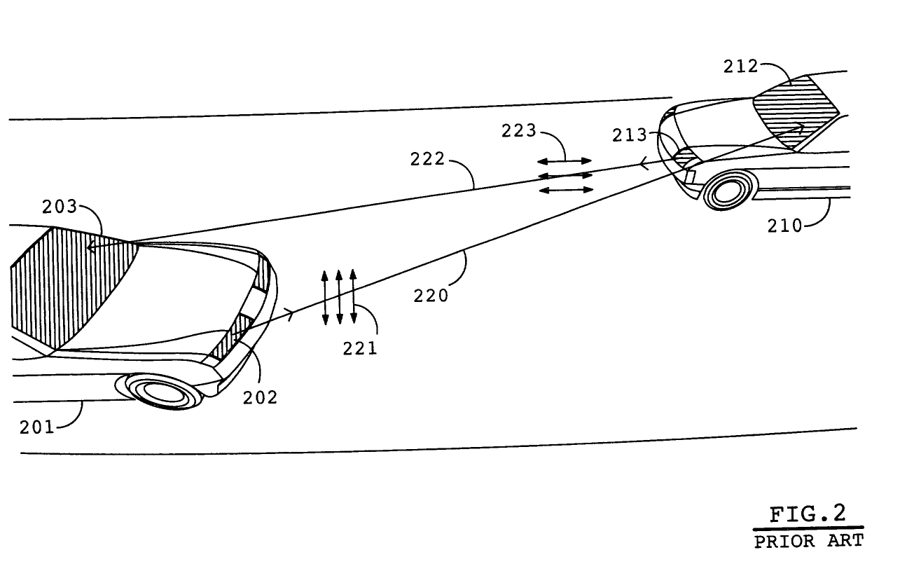

### DETAILED DESCRIPTION OF THE PREFERRED EMBODIMENTS

In overview, the invention is directed to a visibility-enhancing system that includes an adjustment mechanism for adjusting the polarization of a light source relative to the polarization of a viewing filter, so as to improve visual contrast between interposing media and an object to be viewed. The light source includes a light generation mechanism for generating polarized light, and an optional source polarization angle determination mechanism for adjusting the angle of polarization of the light source. The viewing filter includes a filter polarization angle adjustment mechanism for adjusting at least one of the polarization angle of maximum light attenuation and the polarization angle of minimum light attenuation. An observer adjusts at least one of the source polarization angle determination mechanism and the filter polarization angle adjustment mechanism so as to improve the visibility of the object to be viewed in the presence of interposing media.

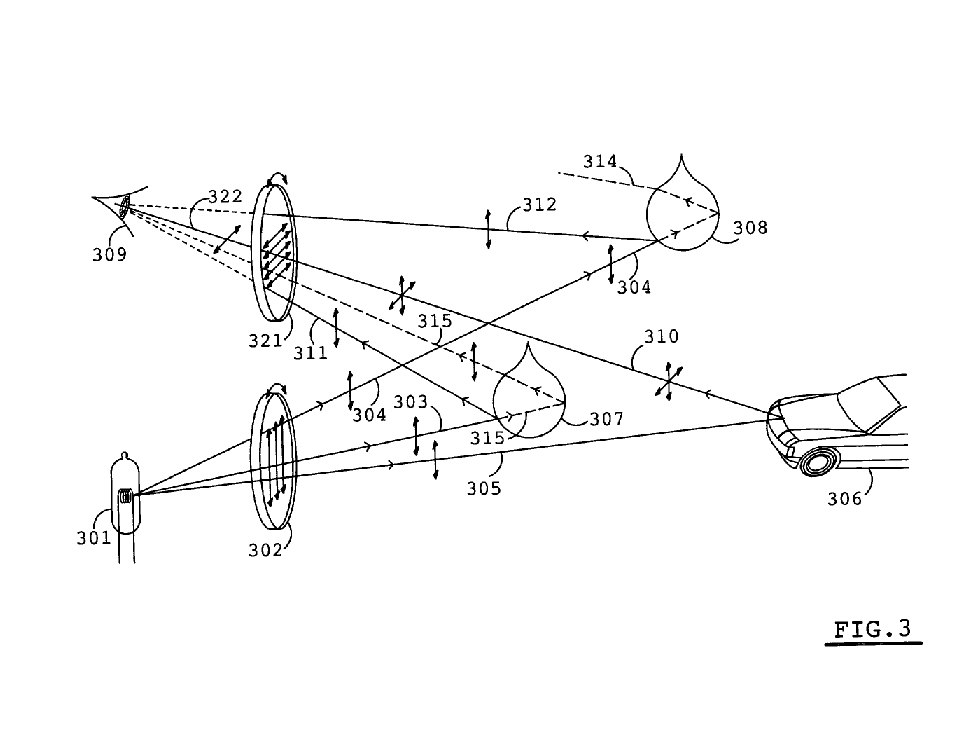

Refer now to FIG. 3 which is a diagrammatic representation of a glare reduction system constructed in accordance with a preferred embodiment of the invention. A light source includes a light generation mechanism in the form of an incandescent lamp 301. However, an incandescent lamp is shown for illustrative purposes, as any of a wide variety of light sources could be employed, including, for example, halogen lamps, fluorescent lights, laser beams, infrared laser beams, and others. If the light generation mechanism emits nonpolarized light, then the light source includes, and/or is coupled to, a filtering mechanism for transforming the nonpolarized light into polarized light. The light source may also include, and/or be coupled to, an optional source polarization angle determination mechanism for adjusting the angle of polarization of the light source. The source polarization angle determination mechanism may, but need not, be combined with the filtering mechanism, as is shown in FIG. 3. Moreover, any combination of discrete or distributed elements may be utilized to implement the light source, the filtering mechanism, and the optional polarization angle determination mechanism. Illustratively, all of the aforementioned functionalities could be implemented by a single element, such as a rotatable laser beam, or each of these functionalities could be provided by discrete elements.

In the example of FIG. 3, the filtering mechanism and the optional polarization angle determination mechanism are provided in the form of an adjustable polarization screen 302. Unpolarized light from incandescent lamp 301 traverses adjustable polarization screen 302, thereby providing polarized light. The screen of FIG. 3 is adjusted such that this polarized light will be vertically polarized for purposes of illustration. A first vertically polarized light ray 303 travels from polarization screen 302 to a first specularly-reflecting object, shown here as a first water droplet 307. A portion of light ray 303 never enters water droplet 307, as it is reflected from the air-droplet interface as reflected light ray 311. It is important to note that reflected light ray 311 retains the same polarization as incident light ray 303. Since light ray 303 is vertically polarized, light ray 311 is also vertically polarized.

In general, not all of the incident light ray 303 is reflected by the air-droplet interface. A portion of the incident light ray 303 is refracted by the air-droplet interface and enters droplet 307 as light ray 315. Light ray 315 traverses droplet 307 until it encounters a droplet-air interface, whereupon a portion of light ray 315 is then reflected by this droplet-air interface back into the droplet 307. Upon encountering another droplet-air interface, a portion of light ray 315 is refracted and emerges from droplet 307 back into air. Throughout these reflections and refractions, light ray 315 retains its sense of polarization. Accordingly, when light ray 315 exits droplet 307, it is vertically polarized. Vertically polarized reflected light ray 311 and vertically polarized refracted light ray 315 travel towards an observer 309.

An adjustable viewing filter 321 intercepts light rays 311 and 315 before these light rays reach observer 309. In the example of FIG. 3, the adjustable viewing filter 321 has been adjusted so as to permit the passage of horizontally polarized light, and so as to substantially attenuate the passage of vertically polarized light. Since light rays 311 and 315 are both vertically polarized, these rays are substantially attenuated by adjustable viewing filter 321. Accordingly, the magnitudes of light rays 311 and 315, as reflected and/or refracted from droplet 307, are substantially reduced from the standpoint of observer 309.

A second vertically polarized light ray 304 travels from polarization screen 302 to a second specularly-reflecting object, shown here as a second water droplet 308. A portion of light ray 304 never enters water droplet 308, as it is reflected from the air-droplet interface as reflected light ray 312. It is important to note that reflected light ray 312 retains the same polarization as incident light ray 304. Since light ray 304 is vertically polarized, light ray 312 is also vertically polarized.

In general, not all of the incident light ray 304 is reflected by the air-droplet interface. A portion of the incident light ray 304 is refracted by the air-droplet interface and enters droplet 308 as light ray 314. Light ray 314 traverses droplet 308 until it encounters a droplet-air interface, whereupon a portion of light ray 314 is then reflected by this droplet-air interface back into the droplet 308. Upon encountering another droplet-air interface, a portion of light ray 314 is refracted and emerges from droplet 308 back into air. Throughout these reflections and refractions, light ray 314 retains its sense of polarization. When light ray 314 exits droplet 308, it is vertically polarized. However, unlike the situation with first water droplet 307, light ray 304 strikes a lower surface of water droplet 308, thereby providing angles of reflection and refraction that do not result in a return of refracted and reflected light ray 314 back towards observer 309. Accordingly, only vertically polarized reflected light ray 312, and not vertically polarized refracted light ray 314, travels toward observer 309.

An adjustable viewing filter 321 intercepts light ray 312 before this light ray reaches observer 309. In the example of FIG. 3, the adjustable viewing filter 321 has been adjusted so as to permit the passage of horizontally polarized light, and so as to substantially attenuate the passage of vertically polarized light. Since light ray 312 is vertically polarized, this ray is substantially attenuated by adjustable viewing filter 321. Accordingly, the magnitude of light ray 312, as reflected and/or refracted from droplet 308, is substantially reduced from the standpoint of observer 309.

A third vertically polarized light ray 305 travels from polarization screen 302 to a first nonspecularly reflecting object, shown here as parked vehicle 306. In practice, vehicle 306 could represent virtually any object to be observed ,by observer 309, such as a building, a train, a person, an animal, a workpiece, a sign, an airplane, a radio tower, a runway, a road surface, a lane marking, or others. In many cases, it is desired to enhance observed visual contrast between vehicle 306 and intervening obstructive media, such as water droplets 307 and 308. This enhancement is brought about through a realization that most objects to be viewed do not reflect light in the same manner as obstructive media, such as, for example, water droplets. Although light ray 305, as incident upon vehicle 306, is vertically polarized, this polarization is not retained upon reflection, absorption and re-emission. When vehicle 306 returns light ray 305, the returned light ray 310 is randomly polarized, and includes both vertical and horizontal polarization components. It is important to note that returned light ray 310 does not retain the same polarization as incident light ray 305.

Randomly polarized reflected light ray 310 travels toward observer 309. An adjustable viewing filter 321 intercepts light ray 310 before this light ray reaches observer 309. In the example of FIG. 3, the adjustable viewing filter 321 has been adjusted so as to permit the passage of horizontally polarized light, and so as to substantially attenuate the passage of vertically polarized light. Since light ray 310 includes both vertical and horizontal polarization components, only the vertical component is substantially attenuated by adjustable viewing filter 321.

A substantial portion of the horizontal polarization component of light ray 310 passes through adjustable viewing filter 321 towards observer 309. Accordingly, the magnitude of light ray 310 reflected from object 310 is not attenuated by adjustable viewing filter 321 to the same degree as the magnitudes of rays 311, 312, and 315 reflected from water droplets 307 and 308. The magnitudes of light rays 311, 312, and 315, as reflected and/or refracted from droplets 307 and 308, are substantially reduced from the standpoint of observer 309. Adjustable filter 321 weakens rays 311, 312, and 315 by a much greater amount than it weakens ray 310 reflected by vehicle 306. Accordingly, the visual contrast between vehicle 306 and water droplets 307 and 308 is enhanced.

The alignment of polarization screen 302 to a vertical polarization and the alignment of adjustable viewing filter 321 to a horizontal polarization is shown for purposes of illustration. Pursuant to one embodiment of the invention, both the polarization screen 302 and viewing filter 321 are adjustable. However, pursuant to a first alternate embodiment, only one of the aforementioned elements—either the polarization screen 302 or the viewing filter 321—is made to be adjustable, and the remaining element is made to be nonadjustable. This alternate embodiment would be useful, for example, in the context of automobile design. An adjustable polarization screen 302 would be provided at the vehicle's headlamps, and the viewing filter 321 would be provided in the form of a nonadjustable windshield light polarization filter. Instead of, or in addition to, providing a windshield light polarization filter, the viewing filter could be provided at a rearview and/or sideview mirror, either in adjustable or nonadjustable form.

All that is required is some mechanism for adjusting the polarization of emitted light relative to that of light to be observed. In the example of FIG. 3, both polarization screen 302 and viewing filter 321 are adjustable, thereby providing an enhanced degree of flexibility. But, irrespective of whether one or both of these elements are adjustable, the polarization of emitted light is adjusted relative to that of light to be observed. This adjustment is performed so as to reduce perceived “glare” returning from specular intervening objects, such as water droplets, and/or to enhance visibility of nonspecular objects to be viewed. When this adjustment is properly implemented, a substantial portion the light perceived as “glare” returning from droplets 307 and 308 will be absorbed by viewing filter 321, thus increasing the relative visibility of light reflected from vehicle 306. Phenomena such as “white-outs” and “fog blindness”, which are actually caused by the presence of moisture (water droplets) in the air, can be greatly ameliorated, thereby increasing safety and visual acuity.

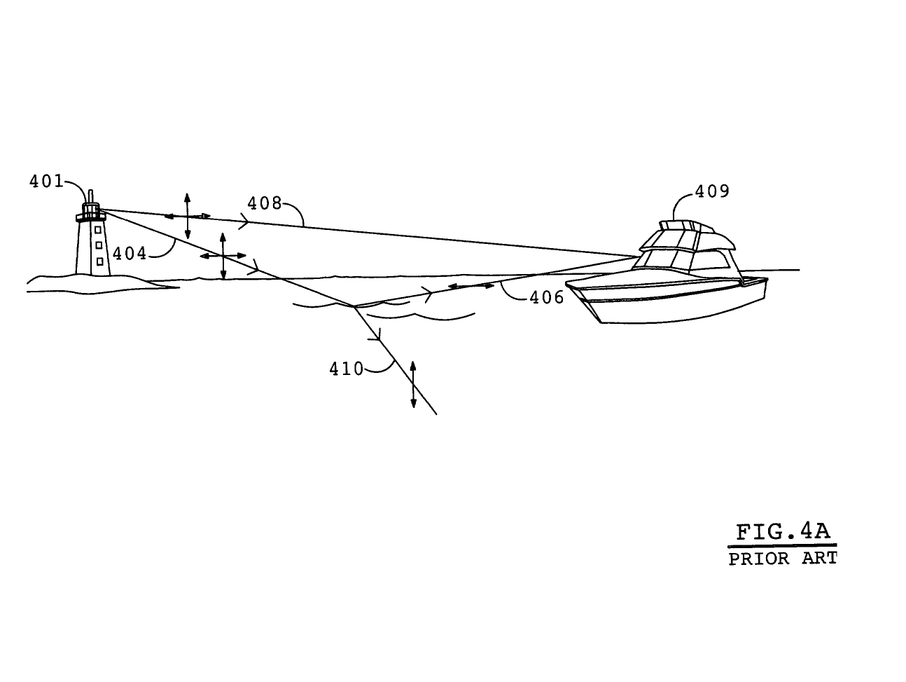

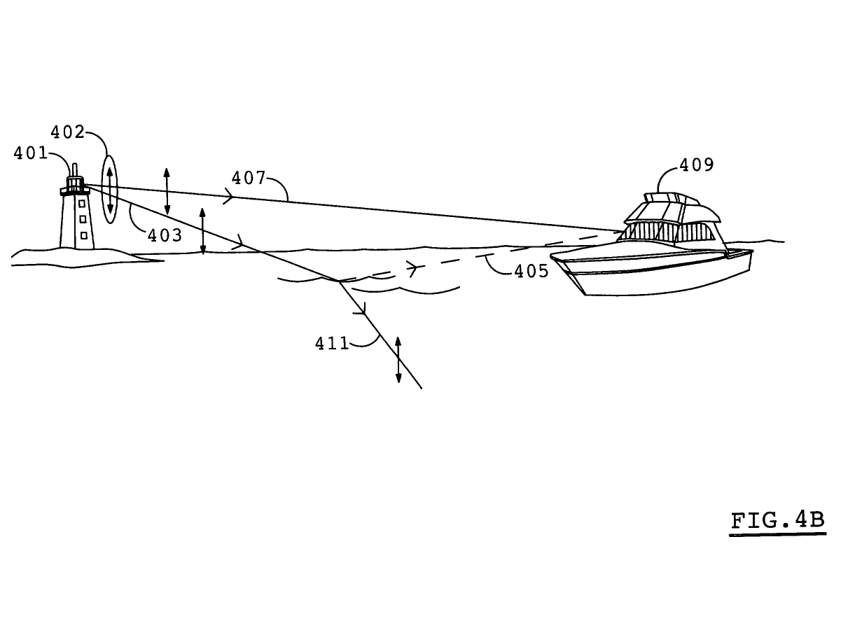

Refer now to FIG. 4A, which is a diagrammatic representation setting forth a prior art illumination technique. A ship 409 is approaching an illumination source 401, which may represent one or more lights at a busy port terminal. Illumination source 401 includes one or more conventional incandescent, halogen, or flourescent lighting elements that emit randomly-polarized light. A randomly-polarized light ray 404, as emitted by illumination source 401, travels towards the surface of an ocean or lake. Upon striking the surface of the water, the vertical polarization components of light ray 404, which are effectively directed downwards into the water surface as light ray 410, are substantially attenuated. However, the horizontal polarization components of light ray 404, which are effectively directed across the water surface, are substantially reflected. The reflected light ray, shown as light ray 406, is horizontally polarized. In some circumstances, the magnitudes of reflected light ray 406 and water-penetrating light ray 410 may also depend upon the spectral output of illumination source 401 at various wavelengths of visible light, as well as the light absorption of a specific body of water as a function of wavelength. In any case, an observer at ship 409 will perceive this horizontally polarized component (light ray 406) as glare across the water. This glare can greatly reduce visibility at ocean ports where a multiplicity of nonpolarized lights are in use. An analagous situation exists in the context of illuminated airport runways. In such operational environments, light is reflected from a damp concrete or asphalt surface, and not from an ocean or a lake. However, the remainder of the analysis is the same. Runway illumination lights reflect off of shiny, wet pavement surfaces, thereby causing glare and impeding visual acuity.

FIG. 4B is a diagrammatic representation setting forth an illumination technique pursuant to a first alternate embodiment of the invention. An illumination source 401 is provided with a polarization filtering mechanism 402. A discrete illumination source 401 and polarization filtering mechanism 402 is shown for purposes of conceptual illustration only, as the functionality of these two elements may be combined into a single element that provides polarized light without the need for a separate filtering element. The polarization filtering mechanism 402, and/or illumination source 401, are aligned such that the emitted light rays are substantially vertically polarized. Virtually all of the emitted rays could be vertically polarized. However, for certain system applications, it is only necessary to vertically polarize some of the emitted light rays. Only those rays that are expected to be directed towards water or pavement surfaces could be vertically polarized, with rays in other directions remaining randomly polarized, or being polarized in directions other than vertically. If the environment includes shiny or highly reflective surfaces that are not substantially horizontally oriented, the polarization of the emitted light towards such surfaces should be oriented perpendicularly to these surfaces, at least if this orientation is possible. In this manner, the polarization of the emitted light is optionally a function of horizontal angular position and/or vertical azimuth as referenced to illumination source 401. Optionally, filtering mechanism 402 could include a wavelength-dependent filtering mechanism that substantially attenuates transmission of certain wavelengths, or that allows transmission of only a selected group of wavelengths. Alternatively, the illumination source 401 itself may be selected to have a desired spectral output as a function of wavelength.

Vertically polarized light ray 403 travels from polarization filtering mechanism 402 towards the surface of the ocean or lake. Upon striking this surface, most of the vertically polarized light is attenuated by the surface of the water, and very little light is reflected back along path 405 towards ship 409. Accordingly, an observer at ship 409 views little, if any, glare caused by illumination source 401 shining across the water.

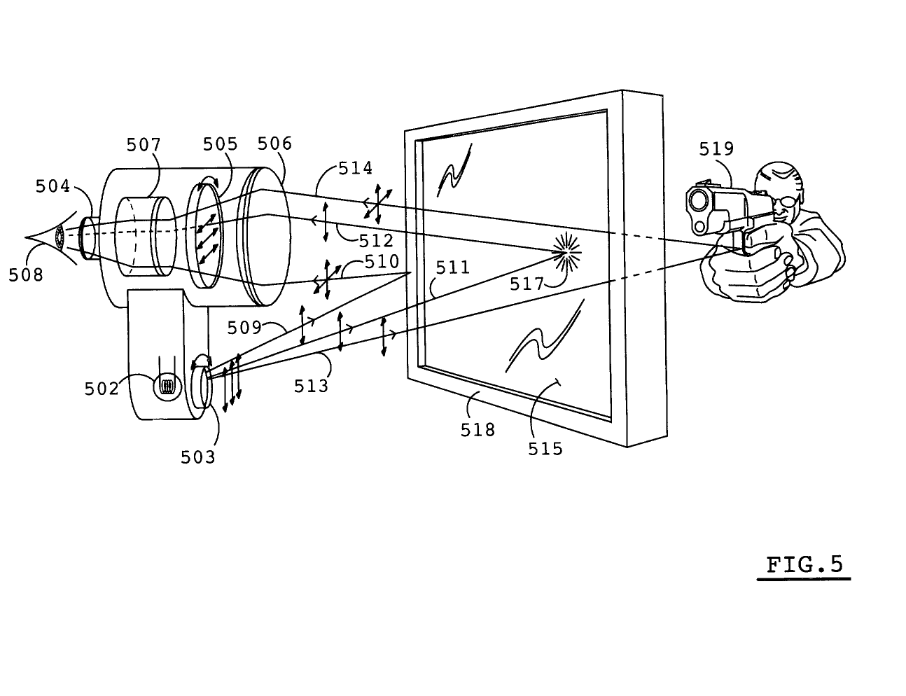

FIG. 5 is a diagrammatic representation of a second alternate embodiment of the invention for use in the context of night vision devices and/or photographic equipment. Night vision devices, as well as photographic equipment, typically utilize a source of illumination 502. In the case of photographic equipment, a flash camera provides a source of illumination 502 in the form of a flash bulb, xenon strobe light, halogen lamp, incandescent lamp, fluorescent lamp, or the like.

In the case of night vision devices, source of illumination 502 is implemented using an infrared radiation source for illuminating an area to be viewed. Some of the illuminated infrared radiation is reflected from objects in the viewing area back towards the night vision equipment. An optical detecting element in the night vision equipment detects this reflected radiation, thereby permitting an infrared image of the viewing area to be developed. Typically, this optical detecting element is a sensitive infrared detecting tube that is optimized to detect relatively low levels of infrared radiation. Such low levels of radiation would be reflected, for example, from a human observation target positioned in the area to be viewed. The detecting tube has a limited dynamic range, and it would be difficult or impossible to design such tubes to handle both very low and very high signal levels. High signal levels may, on occasion, permanently damage the detecting tube, but they will generally overload the tube for a brief interval of one or two seconds. During this overload period, detection of illuminated objects is not possible.

As long as there are not any objects in the field of view that would reflect very strong infrared signals back to the optical detecting element, the night vision equipment operates as it should. However, certain objects reflect infrared radiation much more efficiently than the human body. As a practical matter, glass, plastic, or plexiglass windows are highly efficient reflectors of near infrared radiation, in the range of 780-nanometer to 1000-nanometer wavelengths. When the night viewing equipment illuminates such a window, the window returns a very strong infrared reflection back to the detecting tube, potentially overloading the tube for a few seconds. For hobbyists or casual users, this delay represents a minor annoyance. However, in the context of law enforcement, night viewing equipment is commonly used to aid in drug busts, for returning evasive fugitives to justice, and for repossessing foreclosed assets. These are critical situations where one or two seconds could make the difference between life and death.

Pursuant to one preferred embodiment of the invention, FIG. 5 sets forth an illustrative night vision device 501, and pursuant to another preferred embodiment, the principles set forth in FIG. 5 can be applied to photographic equipment such as flash cameras. Considering the night vision embodiment, the device of FIG. 5 includes enhancements that substantially reduce the overload problem inherent in prior art designs. Night vision device 501 includes a polarized infrared light source with a polarization adjustment mechanism 503. This functionality is illustratively provided by a discrete randomly-polarized infrared source 502 optically coupled to a rotatable polarization screen, although other devices could alternatively be employed to provide the same or similar functionality. Night viewing device 501 also includes an infrared detecting element equipped with an adjustable polarization filter 505. As in the case of the aforementioned infrared source, the detecting element and adjustable polarization filter could be implemented using any combination of discrete and/or integrated elements.

To explain the operation of night vision device 501, assume that polarization adjustment mechanism 503 is adjusted so as to transmit vertically polarized infrared radiation. Also assume that adjustable polarization filter 505 is configured so as to permit detection of horizontally polarized infrared radiation. A first ray 511 of vertically polarized infrared radiation travels from polarization adjustment mechanism 503 to glass panel 515. A substantial portion of infrared radiation incident upon glass panel 515 is reflected from the glass panel and back to night vision device 501, also as vertically polarized infrared radiation. In the context of prior art designs, this reflection will cause glare 517, and it will also cause an overloading of the infrared detecting element.

In the design of FIG. 5, adjustable polarization filter 505 is adjusted to substantially admit horizontally polarized infrared radiation while, at the same time, substantially attenuating vertically polarized infrared radiation. As a result, polarization filter 505 shields the infrared detecting element from the strong reflections returned by glass panel 515. These reflections no longer overload the detecting element, and night vision device 501 will continue to operate normally. For example, a vertically polarized light ray 509 travels from polarization adjustment mechanism 503 to a frame 518 that encases glass panel 515. Frame 518 is illustratively fabricated from wood, painted metal, vinyl, plastic, and/or any of various other typical construction materials that provide nonspecular reflections. Accordingly, upon reflection from frame 518, light ray 509 becomes randomly polarized. Randomly-polarized light ray 509 travels towards polarization filter 505. At least a portion of the horizontal component of randomly-polarized light ray 509 is able to pass through polarization filter 505 to an infrared detecting element within night vision device 501, whereas the vertical component of randomly polarized light ray 509 is substantially attenuated by polarization filter 505. The admitted horizontal component permits night vision device 501 to provide an image of frame 518.

Similarly, a vertically polarized light ray 513 travels from polarization adjustment mechanism 503, through glass panel 515, and onwards to a nonspecular object 519. The polarization of light ray 513 is not affected by its traversal through glass panel 515, and the light ray 513, as incident upon object 519, is still vertically polarized. Object 519 represents any substantially nonspecular object, such as a person, an animal, an automobile, a vehicle, a tree, a plant, a projectile, a sign, or virtually any other object that does not provide substantially specular reflections. Upon reflection from nonspecular object 519, light ray 513 becomes randomly polarized. This randomly-polarized light ray 513 traverses through glass panel 515, with its random polarization substantially unchanged.

Randomly-polarized light ray 513 travels towards polarization filter 505. At least a portion of the horizontal component of randomly-polarized light ray 513 is able to pass through polarization filter 505 to an infrared detecting element within night vision device 501, whereas the vertical component of randomly polarized light ray 513 is substantially attenuated by polarization filter 505. The admitted horizontal component permits night vision device 501 to provide an image of object 519.

Next, the principles set forth in FIG. 5 will be applied in the context of a flash camera. As in the case of night vision device 501, a flash camera is equipped with a polarized light source and a polarization adjustment mechanism 503. This functionality is illustratively provided by a discrete randomly-polarized source 502 optically coupled to a rotatable polarization screen, although other devices could alternatively be employed to provide the same or similar functionality. As compared with the previously described night vision embodiment, source 502 in a camera embodiment is equipped to produce light in the visible spectrum. The infrared detecting element of the night vision embodiment is replaced with either film or a charge-coupled device (CCD) array in the camera embodiment. However, both of these embodiments include an adjustable polarization filter 505, either as a discrete element, or integrated with one or more other system components. For example, a CCD array could be designed to also provide the functionality of an adjustable polarization filter 505, such that a separate, discrete polarization filter is not required.

To explain the operation of an illustrative camera embodiment of the present invention, a flash camera is roughly analagous to the night vision device 501 described in the immediately preceding embodiment. For example, assume that polarization adjustment mechanism 503 is adjusted so as to transmit vertically polarized visible light. Also assume that adjustable polarization filter 505 is configured so as to permit detection of horizontally polarized visible light. A first ray 511 of vertically polarized light travels from polarization adjustment mechanism 503 to a glass panel 515. A portion of visible light incident upon glass panel 515 is reflected from the glass panel and back to camera, also as vertically polarized visible light. In the context of prior art designs, this reflection will cause glare 517, and it may also ruin any photos taken by a flash camera positioned in the general vicinity of a highly reflective surface. These reflections may obscure, dominate, or disturb the aesthetic appeal of photographs taken by the flash camera. Potentially problematic surfaces include, but are not limited, to windows, mirrors, highly polished furniture, metallic objects, bodies of water, swimming pools, wet surfaces, and the like.

In the design of FIG. 5, adjustable polarization filter 505 is adjusted to substantially admit horizontally polarized visible light while, at the same time, substantially attenuating vertically polarized light. As a result, polarization filter 505 shields the film or CCD device from the strong reflections returned by glass panel 515. Of course, this glass panel 515 is representative of any potentially problematic surface, as described in the preceding paragraph, and may or may not be present in the form of glass. In any case, reflections from glass panel 515 or another potentially problematic surface will no longer be captured by the film or CCD and, hence, will no longer appear as distracting, obscuring, or unattractive elements in a photograph.

The foregoing scheme would be useless if desired objects were also eliminated from view. But, by providing a mechanism (503, 505) to adjust the polarization of a light illumination source (502) relative to the polarization of received light (i.e, light captured by film, a CCD device, and/or the human eye), a desired amount of reflections from other, non-problematic objects will be captured by the CCD device or the film. For example, consider a vertically polarized light ray 509 that travels from polarization adjustment mechanism 503 to a frame 518 that encases glass panel 515. Frame 518 is illustratively fabricated from wood, painted metal, vinyl, plastic, and/or any of various other typical construction materials that provide nonspecular reflections. Accordingly, upon reflection from frame 518, light ray 509 becomes randomly polarized. Randomly-polarized light ray 509 travels towards polarization filter 505. At least a portion of the horizontal component of randomly-polarized light ray 509 is able to pass through polarization filter 505 to film or a CCD device, whereas the vertical component of randomly polarized light ray 509 is substantially attenuated by polarization filter 505. The admitted horizontal component permits a camera to provide an image of frame 518.

Similarly, a vertically polarized light ray 513 travels from polarization adjustment mechanism 503, through glass panel 515, and onwards to a nonspecular object 519. The polarization of light ray 513 is not affected by its traversal through glass panel 515, and the light ray 513, as incident upon object 519, is still vertically polarized. Object 519 represents any substantially nonspecular object, such as a person, an animal, an automobile, a vehicle, a tree, a plant, a projectile, a sign, or virtually any other object that does not provide substantially specular reflections. Upon reflection from nonspecular object 519, light ray 513 becomes randomly polarized. This randomly-polarized light ray 513 traverses through glass panel 515, with its random polarization substantially unchanged.

Randomly-polarized light ray 513 travels towards polarization filter 505. At least a portion of the horizontal component of randomly-polarized light ray 513 is able to pass through polarization filter 505 to film or a CCD device, whereas the vertical component of randomly polarized light ray 513 is substantially attenuated by polarization filter 505. The admitted horizontal component permits a camera to provide an image of object 519.

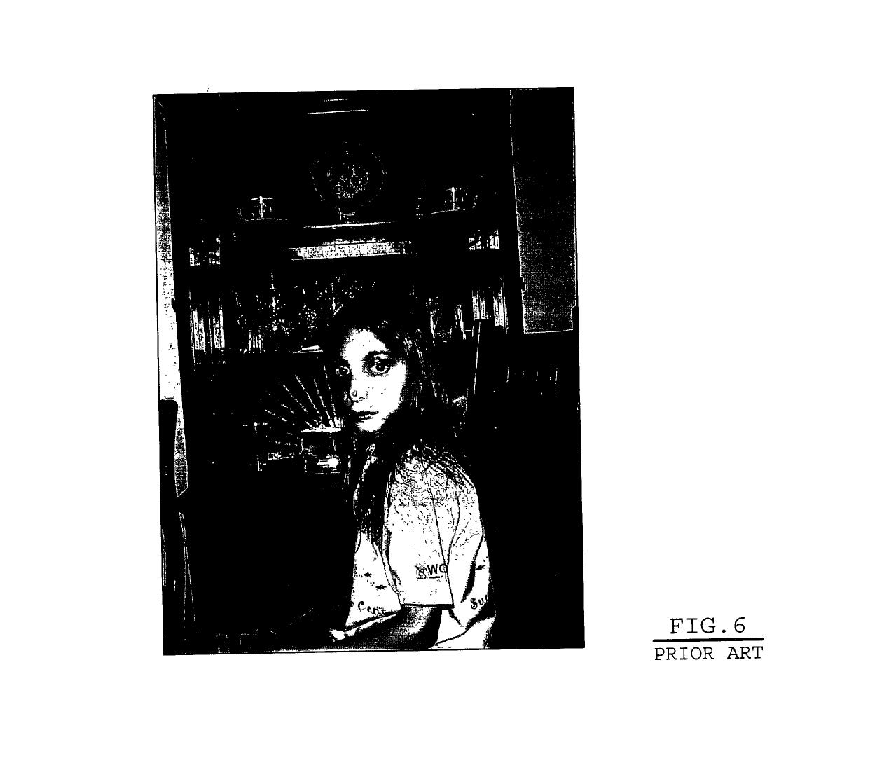

FIG. 6 is an illustrative color photograph taken in accordance with prior art flash illumination techniques that do not employ polarization filters. The color photograph shows a scene with the subject—a young girl—in the foreground, and specularly reflective objects in the background. Observe that he subject has a pale cast across her face and hair. Notice the sparkle in the subject's eyes. Note as well the shiny, pale reflections upon her hair, nose, and forehead.

Now, focus upon the background objects. In the example of FIG. 6, this is an easy task, because the background objects really compete with the subject for your attention. Pursuant to prior art flash photography illumination techniques, reflections from bright objects in the background create distracting visual competition. Note the harsh horizontal reflection below the upper shelf, and the harshness of reflections from bright silver objects on the lower shelf, near the subject's right shoulder.

To summarize, there is simply too much information in the photograph of FIG. 6. The subject appears “filmy” or “washed-out”. Moreover, the scene is rather confusing, as background objects tend to visually overwhelm the subject.

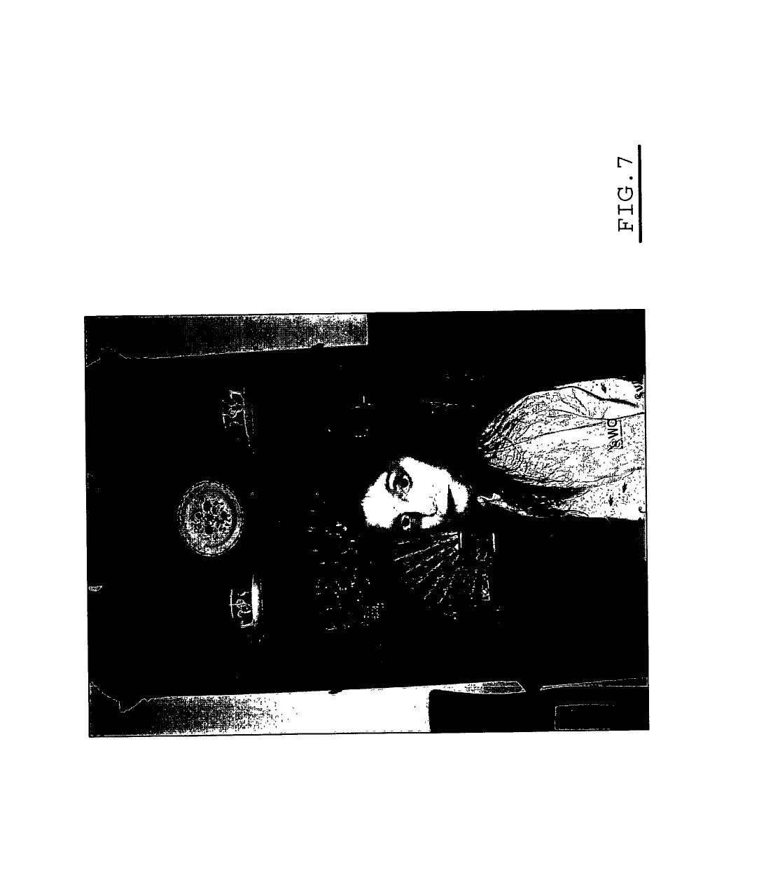

FIG. 7 is an illustrative color photograph taken using a system similar to that of FIG. 5, wherein the polarization angle between an illumination source polarization filter and a light receiving polarization filter is adjusted to be almost orthogonal. The filmy, pale cast of FIG. 6 is no longer present, and the subject has retained her normal skin tone. The distracting background of FIG. 6 has been virtually eliminated, to the extent that plates, dishes, teapots, and other decorative objects in the breakfront cabinet no longer compete with the subject for attention. Of course, this effect may or may not be desired by a given photographer, or in a given situation. But, of greater importance, the techniques disclosed herein provide mechanisms by which the photograph-taking process can be adjusted to achieve a desired, improved, enhanced, and/or specified result.

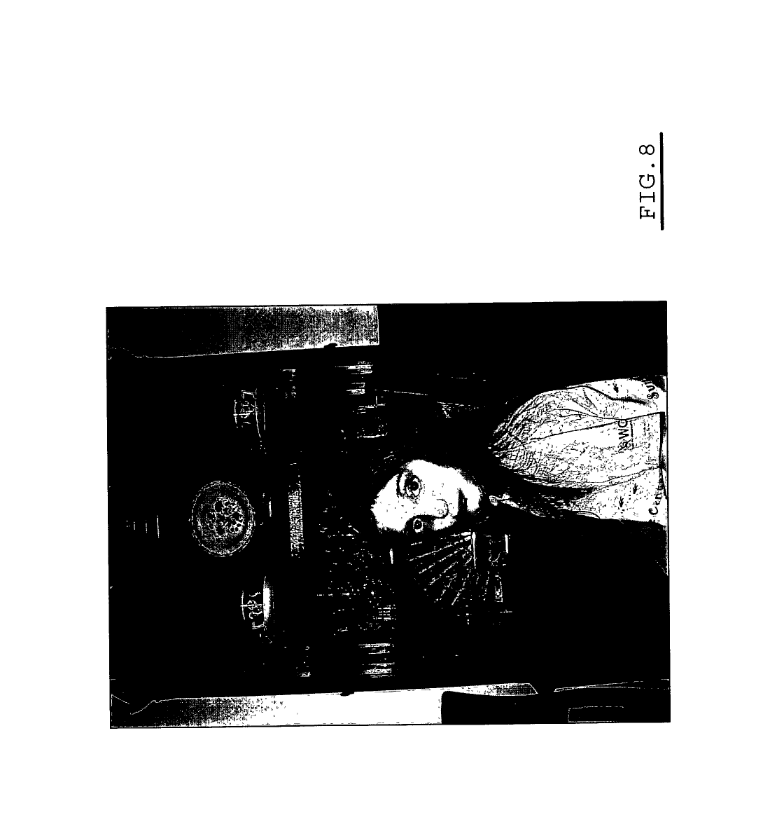

FIG. 8 is an illustrative color photograph taken using a system similar to that of FIG. 5, wherein the polarization angle between an illumination source polarization filter and a light receiving polarization filter is adjusted to an intermediate point between identical polarization and orthogonal polarization, so as to enhance a specific scene. For example, assume that a photographer wishes to de-emphasize the background objects shown in FIG. 6, including the dishes, teapots, and plates, but, at the same time, he does not want to obscure these objects as much as is shown in FIG. 7. With reference to FIG. 8, the predominance of background objects has been reduced relative to prior art techniques (FIG. 6), but not to as great an extent as what is shown in FIG. 7.

As is apparent upon comparing FIG. 8 to FIGS. 6 and 7, the photograph-taking process can be adjusted to reduce the visibility of certain elements in a photographic scene relative to other elements, and this visibility can be reduced by an adjustable amount. For example, the visibility of dishes, teapots, and other background objects can be reduced. Likewise, the photograph-taking process can be adjusted to enhance the visibility of certain elements in the scene relative to other elements, and this visibility can also be enhanced by an adjustable amount. For instance, the visibility of the. subject (the young girl) can be enhanced. Visibility is enhanced or degraded, for instance, by enhancing or degrading the contrast of a first object relative to a second object, through the use of polarized light.

Although the techniques of FIGS. 6, 7, and 8 operate in the context of photography, other applications exist for visibility-enhancing systems that provide mechanisms for adjusting visibility between a first object and a second object. If such a system is employed in the context of automobiles, trucks, railroad engines, airplanes or ships, the advantages of an adjustable system relative to a fixed system are marked. Whereas the elimination of background elements as shown in FIG. 7 could be desirable in connection with a photograph, the elimination of background elements in the operational environment of transportation could have disastrous consequences. For example, assume that a visibility-enhancing system is provided wherein the polarization of the light source relative to the polarization of a light filtering mechanism interposed in front of the human eye are fixedly arranged at a ninety-degree (orthogonal) angle. This setup will minimize reflections from interposing specular media such as rain, snow, and fog. But it may also eliminate reflections from other interposing specular media in the form of car bumpers, airplane wings, and oncoming trains. However, by providing an adjustment mechanism by which the relative polarization between the light source and the filtering mechanism can be changed, visibility can be improved in icy or rainy conditions, without dangerously restricting the visibility of large oncoming specular objects at the same time.

The above described arrangement is merely illustrative of the general principles of the present invention. Numerous modifications and adaptations thereof will be readily apparent to those skilled in the art without departing from the spirit and scope of the present invention.

We claim:

1. A system for enhancing visibility in the presence of specular media, the system comprising:
(a) a light source including, or coupled to, a source polarization mechanism for generating polarized light that is substantially polarized at a light source polarization angle;
(b) an observation filter having a filter polarization angle which, when said filter polarization angle is adjusted relative to the light source polarization angle, provides at least one of (i) relatively maximum light attenuation, or (ii) relatively minimum light attenuation; and
(c) a mechanism for adjusting the source polarization mechanism relative to the filter polarization angle, so as to change visual contrast between specular media and at least one of (i) an object to be viewed through the observation filter and (ii) an object to be photographed through the observation filter.

2. The system of claim 1 wherein the specular media comprise at least one of water droplets, ice, snow, fog, rain, sleet, hail, dust, dirt, metallic particles, and particles of sand.

3. The system of claim 2 wherein the light source, polarization angle is substantially fixed, such that the mechanism for adjusting the source polarization mechanism relative to the filter polarization angle adjusts the filter polarization angle.

4. The system of claim 2 wherein the filter polarization angle is substantially fixed, such that the mechanism that adjusts the source polarization mechanism relative to the filter polarization angle, adjusts the source polarization mechanism.

5. The system of claim 2 wherein the filter polarization angle is adjustable and the light source polarization angle is also adjustable, and the mechanism for adjusting the source polarization mechanism relative to the filter polarization angle adjusts at least one of the source polarization mechanism and the filter polarization angle.

6. The system of claim 2 wherein the filter polarization angle is adjustable and the light source polarization angle is also adjustable, and the mechanism for adjusting the source polarization mechanism relative to the filter polarization angle automatically adjusts the source polarization mechanism in response to a user manually adjusting the filter polarization angle.

7. The system of claim 2 wherein the filter polarization angle is adjustable and the light source polarization angle is also adjustable, and the mechanism for adjusting the source polarization mechanism relative to the filter polarization angle automatically adjusts the filter polarization angle in response to a user manually adjusting the source polarization mechanism.

8. A method for enhancing visibility in the presence of specular media, the method comprising the steps of:
(a) generating polarized light that is substantially polarized at a light source polarization angle;
(b) filtering polarized light with an observation filter having a filter polarization angle which, when said filter polarization angle is adjusted relative to the light source polarization angle, provides at least one of (i) relatively maximum light attenuation, or (ii) relatively minimum light attenuation; and
(c) adjusting the light source polarization mechanism relative to the filter polarization angle, so as to change visual contrast between specular media and at least one of (i) an object to be viewed through the observation filter and (ii) an object to be photographed through the observation filter.

9. The method of claim 8 wherein the specular media are interposing between a light source and a viewer, and the media comprise at least one of water droplets, ice, snow, fog, rain, sleet, hail, dust, dirt, metallic particles, and particles of sand.

10. The method of claim 9 wherein the light source polarization angle is substantially fixed, such that the step of adjusting the source polarization angle relative to the filter polarization angle is performed by adjusting the filter polarization angle.

11. The method of claim 9 wherein the filter polarization angle is substantially fixed, such that the step of adjusting the source polarization angle relative to the filter polarization angle is performed by adjusting the source polarization angle.

12. The method of claim 9 wherein the filter polarization angle is adjustable and the light source polarization angle is also adjustable, and the step of adjusting the source polarization angle relative to the filter polarization angle is performed by adjusting both the source polarization angle and the filter polarization angle.

13. The method of claim 9 wherein the filter polarization angle is adjustable and the light source polarization angle is also adjustable, and the step of adjusting the light source polarization angle relative to the filter polarization angle includes the step of the filter polarization angle being automatically adjusted in response to a user manually adjusting the light source polarization angle.

14. The method of claim 9 wherein the filter polarization angle is adjustable and the light source polarization angle is also adjustable, and the step of adjusting the light source polarization angle relative to the filter polarization angle includes the step of the light source polarization angle being automatically adjusted in response to a user manually adjusting the filter polarization angle.

15. A system for enhancing visibility in the presence of a glare-producing surface, the system comprising:
(a) a light source including, or coupled to, a source polarization mechanism for generating polarized light that is substantially polarized at a light source polarization angle; and
(b) a mechanism for adjusting the source polarization mechanism relative to the glare-producing surface, so as to reduce the amount of light from the light source that is reflected by the glare-producing surface.

16. The system of claim 15 wherein the source polarization mechanism polarizes light at an angle within approximately thirty degrees of perpendicular to the glare-producing surface.

17. The system of claim 16 wherein the source polarization mechanism polarizes light at an angle substantially perpendicular to the glare-producing surface.

18. The system of claim 15 wherein the glare-producing surface is at least one of: the surface of a body of water, a concrete surface, an asphalt surface, and a surface of a building.

19. A method for enhancing visibility in the presence of a glare-producing surface, the method comprising the steps of:
(a) generating polarized light that is substantially polarized at a light source polarization angle; and
(b) adjusting the source polarization mechanism relative to the glare-producing surface, so as to reduce the amount of light from the light source that is reflected by the glare-producing surface.

20. The method of claim 19 wherein step (a) is performed such that the polarized light is polarized at an angle within approximately thirty degrees of perpendicular to the glare-producing surface.

21. The method of claim 20 wherein step (a) is performed such that the polarized light is polarized at an angle substantially perpendicular to the glare-producing surface.

22. The method of claim 19 wherein the glare-producing surface is at least one of: the surface of a body of water, a concrete surface, an asphalt surface, and a surface of a building.

23. An infrared-based system for enhancing night vision in the presence of an object that produces infrared glare, the system comprising:
(a) an infrared light source including, or coupled to, a source polarization mechanism for generating polarized light that is substantially polarized at a light source polarization angle;
(b) an observation filter for filtering polarized infrared light, the observation filter having a filter polarization angle which, when said filter polarization angle is adjusted relative to the light source polarization angle, provides at least one of (i) relatively maximum infrared light attenuation, or (ii) relatively minimum infrared light attenuation; and
(c) a mechanism for adjusting the source polarization mechanism relative to the filter polarization angle, so as to change visual contrast between an object to be viewed and the object that produces infrared glare.

24. The system of claim 23 wherein the light source polarization angle is substantially fixed, such that the mechanism for adjusting the source polarization mechanism relative to the filter polarization angle adjusts the filter polarization angle.

25. The system of claim 23 wherein the filter polarization angle is substantially fixed, such that the mechanism for adjusting the source polarization mechanism relative to the filter polarization angle adjusts the source polarization mechanism.

26. The system of claim 23 wherein the filter polarization angle is adjustable and the light source polarization angle is also adjustable, and the mechanism for adjusting the source polarization mechanism relative to the filter polarization angle adjusts both the source polarization mechanism and the filter polarization angle.

27. The system of claim 23 wherein the filter polarization angle is adjustable and the light source polarization angle is also adjustable, and the mechanism for adjusting the source polarization mechanism relative to the filter polarization angle automatically adjusts the source polarization mechanism in response to a user manually adjusting the filter polarization angle.

28. The system of claim 23 wherein the filter polarization angle is adjustable and the light source polarization angle is also adjustable, and the mechanism for adjusting the source polarization mechanism relative to the filter polarization angle automatically adjusts the filter polarization angle in response to a user manually adjusting the source polarization mechanism.

29. An infrared-based method for enhancing night visibility in the presence of an object that produces infrared glare, the method comprising the steps of:
(a) generating polarized infrared light that is substantially polarized at a light source polarization angle;
(b) filtering polarized infrared light with an observation filter which, when said observation filter is adjusted relative to the light source polarization angle, provides a filter polarization angle of at least one of (i) relatively maximum infrared light attenuation, and (ii) relatively minimum infrared light attenuation; and
(c) adjusting the light source polarization angle relative to the filter polarization angle, so as to change visual contrast between an object to be viewed and the object that produces infrared glare.

30. The method of claim 29 wherein the light source polarization angle is substantially fixed, such that the step of adjusting the source polarization angle relative to the filter polarization angle is performed by adjusting the filter polarization angle.

31. The method of claim 29 wherein the filter polarization angle is substantially fixed, such that the step of adjusting the light source polarization angle relative to the filter polarization angle is performed by adjusting the light source polarization angle.

32. The method of claim 29 wherein the filter polarization angle is adjustable and the light source polarization angle is also adjustable, and the step of adjusting the light source polarization angle relative to the filter polarization angle is performed by adjusting both the light source polarization angle and the filter polarization angle.

33. The method of claim 29 wherein the filter polarization angle is adjustable and the light source polarization angle is also adjustable, and the step of adjusting the light source polarization angle relative to the filter polarization angle is performed by automatically adjusting the light source polarization angle in response to a user manually adjusting the filter polarization angle.

34. The method of claim 29 wherein the filter polarization angle is adjustable and the light source polarization angle is also adjustable, and the step of adjusting the light source polarization angle relative to the filter polarization angle is performed by automatically adjusting the filter polarization angle in response to a user manually adjusting the light source polarization angle.
